(19) United States
(12) Patent Application Publication
(10) Pub. No.: US 2009/0202682 A1
(43) Pub. Date: Aug. 13, 2009

(54) MULTILAYER FOOD PRODUCT AND METHOD FOR PREPARING SAME

(75) Inventors: Jean-Jacques Moreau, Manerbe (FR); Marion Hofmann, Victoria (AU); Jean-Emmanuel Serre, Le Mesnil-Eudes (FR)

Correspondence Address: WINSTON & STRAWN LLP;PATENT DEPARTMENT, 1700 K STREET, N.W., WASHINGTON, DC, 20006, US

(73) Assignee: NESTEC S.A.

(21) Appl. No.: 11/996,934

(22) PCT Filed: Jul. 27, 2006
(86) PCT No.: PCT/FR06/01842

§ 371 Date: Jul. 21, 2008

(30) Foreign Application Priority Data
Jul. 28, 2005 (FR) 0508077

(51) Int. Cl. A23G 3/54; A23G 3/02

(52) U.S. Cl. 426/103; 99/644

(57) ABSTRACT

The invention concerns a multilayer food product and a method for obtaining a multilayer food product. The product includes at least one lower layer and one upper layer of thermally stable food components, wherein the lower layer has a lower viscosity and the upper layer has a uniform distribution.

The invention relates to a process enabling a multi-layer foodstuff, in particular a multi-layer dessert, including at least a sub-base and an upper-base (or coating), the aforementioned sub-base having a low viscosity, each layer containing thermally stable food components, in which the upper-base (or coating) displays a uniform distribution, in particular when the aforementioned upper-base (or coating) is made up of fat content or a food matter having a density higher than that of the sub-base.

The invention also involves a multi-layer foodstuff, in particular, including at least a sub-base and an upper-base (or coating) containing thermally stable food components, in which the aforementioned sub-base has a low viscosity, and in particular such a product in which the upper-base (or coating) is made up of fat content.

Later on in this description, we will preferably name the upper-base “coating.” Generally, the multi-layer foodstuff includes only two layers, namely a base layer of product to be covered and a upper-base layer of a coating.

By “sub-base”, we mean the layer of product to be covered or food component to cover which is the immediate lower part of the upper-base (or coating), regardless of the fact that the final multi-layer foodstuff can include several sub-bases and coatings.

By “multi-layer foodstuff”, we mean a foodstuff including at least a sub-base and an upper-base such as abovementioned, the sub-base being able to include in a non-restrictive way any thermally stable food component, in particular containing milk (fermented or not, whipped or not), fruits, cereals, eggs etc.

By “sub-base having a low viscosity”, we mean that, during the proportioning of the food matter making up the upper-base, the sub-base is not solid, i.e. it does not hold together by itself and that it is likely to spread itself out or to run out if it is not contained in a container.

The aforementioned sub-base can thus have a fluid consistency.

In particular, the aforementioned sub-base can have a viscosity in the range of 3000 to 25000 mPa·s, preferably in the range of 8000 to 20000 mPa·s.

The measurement of viscosity can be taken using a viscometer Brookfield RVDV II+, by using a mobile 93, with a number of revolutions of 5 rpm, at a temperature of 15° C.

Preferably, measurement is made in the container containing the aforementioned sub-base, after approximately a rotation turn from the module, for instance after 10 s.

Alternatively, the aforementioned sub-base can have a Bostwick consistency higher than 8 cm. Bostwick consistency is defined by the measurement of the course of a product flow on a 20° C.-inclined level in 120 s. We can, for example, make this measurement using a device marketed by CSC Scientific Company Inc. (USA) or Kinematica AG (Switzerland).

Among the processes known to obtain multi-layer desserts, the processes of the under-pressure pulverization type (“spraying”) are largely used. However, due to the energy contribution to fat content drops resulting from the pressure, the drops strike the product surface, which they can damage, and the fat content is especially distributed at the edge, bringing potential brittleness of this layer in the container's center, during transport and handling.

Such a process is described in document EP-A-770 332.

In addition, at the time of this percussion, fat content drops can imprison air micro bubbles, which is likely to bring an undesired dark aspect to the layer of fat content, in particular when it is chocolate.

Known too are processes of the atomizing type, like the one described in document DE 2,239,986, used for example for the cover of hard surfaces like cakes: in this case, the fat content is conveyed by compressed air at a short distance on the surface to cover, which prevents its use on a soft surface.

Glazing processes, such as cake glazing by a layer based on sugar, i.e. a solid sub-base cover, are also known in the food field. In such processes, the coating can be carried out by scraping the glazing matter on the solid sub-base and/or by expulsion under pressure of the glazing matter.

The technical problem to solve therefore consists of obtaining a multi-layer foodstuff in which the upper-base (or coating) displays a uniform distribution and a satisfactory aspect for the consumer, in particular when the sub-base and the upper-base display are incompatible due to upper-base's spreading out, i.e. spreading out cannot be done naturally by simply laying the upper-base on the sub-base.

Such a case arises, for example when the sub-base is hydrophilic and the upper-base is hydrophobic, because of the hydrophilic/hydrophobic tensions which prevent spreading out, and/or when the sub-base has a low viscosity, insofar as spreading out cannot be forced without causing the penetration of the upper-base in the sub-base.

It has now been found out that by laying the food matter making up the upper-base (or coating) without involving pressure and use of compressed air, and while applying to the sub-base a force allowing the spreading out of the upper-base, which mitigates this incompatibility, one could obtain a uniform food matter upper-base, continues, in particular if the sub-base has a low viscosity.

Following the inventive process, the food matter making up the upper-base (or coating) is subjected to a controlled release in a mechanical way by multiple openings, whereas the pot containing the product to be covered is subjected to a centrifugal and/or alternative force.

By “alternative force”, we mean the container is subjected to a reciprocating motion, for example a side displacement.

According to a preferred aspect, the food matter making up the upper-base (or coating) has a fat content.

In this case, the inventive process gainfully allows, in spite of the hydrophobic nature of the fat content drops, and the possibly hydrophilic nature of surface on which they are deposited, a uniform laying in thin layer, continues, without damaging the superficial structure of the product to be covered.

Moreover, the inventive process allows obtaining a multi-layer foodstuff in which the upper-base (or coating) is uniformly distributed.

Advantageously, the aforementioned upper-base (or coating) displays a better impact resistance because of this uniform distribution than products obtained by former artistic processes and a more aesthetic aspect (no projection on the container's edges), while keeping easy breaking capability for a spoon. This resistance to breaking is also quantifiable by a texture analysis and a test of rupture (Measurement with TAXT2 Texture Analyzer from company Stable Micro Systems, 4 mm diameter cylinder SMS P/4, speed 0.5 mm/s, depth 2 mm). It is, preferably, higher than or equal to 200 G.

By “uniform distribution”, we mean that, after laying, the upper-base (or coating) has appreciably the same thickness in any point of its surface.

The aforementioned process particularly suitable in the case of acidic or fermented dairy products which have low viscosity and for which it is difficult to lay a coating without damaging the sub-base's surface.

By “acidic or fermented dairy product”, we mean a product containing fermented milk or acidified milk, having acid or neutral pH, such as, for example, soft white cheese, a fermented product containing live ferments, such as yoghurt or some specialty containing fermented milk. The acidification can, for example, be carried out using lactic, citric or phosphoric acid. The ferments can, for example, be chosen among Lactobacillus casei, Lactobacillus bulgaricus, Lactobacillus acidophilus, Streptococcus thermophilus, bifidus etc.

The process according to the invention calls upon the combination of proportioning, distribution and positioning means of the storage containing the product to be covered.

Preferably, the inventive process includes the following steps:
proportioning the food matter making up the upper-base (or coating),
distributing the aforementioned matter using a rotating mechanical bushel through a plate provided with multiple openings on the surface of a product to cover constituting at least a sub-base contained beforehand in a container, and
simultaneously, to subject the aforementioned container to a centrifugal
   or alternative force.

Preferential conditions of the process can be selected among the following ones:
at least a sub-base is hydrophilic and at least an upper-base is hydrophobic;
the food matter making up the upper-base (or coating) is a fat content;
the proportioning of the food matter making up the upper-base (or coating) can be carried out using a proportioning piston;
the push of the proportioning piston is controlled so as not to give kinetic energy to the drops to be laid. Preferably, we will exert a push allowing the release of the food matter making up the upper-base (or coating) by the only effect of the force of gravity of the aforesaid food matter;
the proportioning of the food matter making up the upper-base (or coating), when it has a high viscosity (up to 30000 mPa·s), can be carried out using a positive pump;
the force applied to the container is, preferably, adjusted to cause the displacement of the food matter drops making up the upper-base (or coating), and not that of the product to be covered making up at least a sub-base contained in the container; in particular, a centrifugal force by the rotation of the pot of about 1 to 5 s⁻¹, in particular about 1 to 3.5 s⁻¹ for fluid products, and about 3 to 5 s⁻¹ for more viscous products;
the temperature during the release of the food matter making up the upper-base (or coating) is adjusted so as to maintain the food matter in liquid phase, for example about 30 with 75° C., preferentially 60 with 70° C.

By “rotating mechanical bushel”, still called turning valve, one gradually understands a machine element, machined preferentially with a surface punt, which, under the action of rotation, come to release, and in a controlled way, the whole of the openings of distribution located on the provided plate of the previously mentioned openings (plate of tube). The amount released by each opening is, by this intermediary, appreciably the same one.

Advantageously, the inventive process also makes it possible to solve the problem of the tube overfilling, often met during the use of processes of under pressure pulverization (“spraying”).

Indeed, the openings of the plate of tube used in the process of the invention can have a diameter of about 0.5 to 4 mm, which allows the inclusion of particles in the food matter making up the upper-base (or coating).

Because of the broad adaptability of the inventive process, there is no particular limitation to observe the choice of the food matter making up the upper-base (or coating).

According to an aspect of the process according to the invention, the end product includes only one sub-base of food component to cover, and only one upper-base (or coating) of food matter.

Alternatively, the invention also relates to obtaining a multi-layer foodstuff including an alternation of sub-base and upper-base (or coating), the aforementioned upper-base (or coating) being able itself to consist of several layers.

The aforementioned food matter must be able to be treated thermally to respect the statutes in force, in particular to be sterilized or pasteurized.

As non-restrictive examples, one can the fat content or the mixtures of selected fat content among the chocolate, of the vegetable fat content of cocoa butter type or other, such as for example the copra grease hardened, or of the made up products containing chocolate

By chocolate, we understand a mixture of cocoa butter, powder cocoa or cocoa liquor, sugar and flavors, with a cocoa butter content from 50 to 90% of the mixture's weight.

One can also use blended products or compounds containing chocolate including, for example, a mixture of another vegetable fat content or cocoa butter, for example copra hardened grease, cocoa powder or water, cocoa liquor, of natural or artificial flavors, such as for example of vanilla, and sweetening substances, with a content of cocoa butter or another vegetable fat from 50 to 100% of the weight of the mixture.

The aforementioned food matter can also be selected among sugar syrups (glucose syrup, maple syrup, caramel etc), products containing fruits (sauce, marmalade, compote, mashed fruits, etc), products containing milk (thick cream etc.), alone or mixed with one or more food additives, such as thickening and/or gelling and/or texturing agents, for example, the galactomannanes, pectins, alginates, carrageenans, xanthane gum, gelatin and/or starches.

It can also include one or more ingredients chosen among natural or artificial dyes or natural or artificial flavors.

It can also contain particle-shaped solid additives such as, for example dry or crystallized fruit fragments; nut fragments, hazelnuts, almonds, citrus peels, fruits; cereals, confectionery vermicelli etc.

The process according to the invention allows inclusion of the previously mentioned particle-shaped solid additives in the food matter making up the upper-base (or coating), in which they can be thermally treated, sterilized in particular. After laying the previously mentioned the layer, the aforementioned particle-shaped solid additives can appear on the surface of the upper-base, without deteriorating the uniform distribution of it.

As an alternative in the process, one second food-layer of matter can cover the first, the aforementioned particle-shaped solid additives being then in between the two coatings.

As another alternative, the aforementioned particle-shaped solid additives can be added on the coating after laying this one and before its total cooling.

The product to be covered, making up at least a sub-base, is a food matter being able to be thermally treated, without limitation to its viscosity.

As non-restrictive examples, we can quote acidic or fermented dairy products, such as, for example, yoghurts or fresh cheeses, foams (whipped dairy product), creams (lacteous phase containing gelling agents) or a product containing fruits (compote, fruit mousse), the products containing cereals (lacteous phase containing minced or wholegrain cereals), fermented products containing cereals, products containing eggs like crèmes aux œufs or products containing soy.

The aforementioned product to be covered can in particular have a Bostwick consistency, such as abovementioned, higher than 8 cm.

Alternatively, it can have a viscosity of about 3000 to 25000 mPa·s, preferably of order 8000 to 20000 mPa·s.

The process according to the invention can favorably be implemented when the product making up the sub-base and the characteristics of the layer of the food matter making up the upper-base (or coating) to lay on its surface display an incompatibility.

We can for example quote the following cases:
the laying of a layer of fat content on a hydrophilic sub-base, for example a layer of chocolate on a crème dessert;
the laying of a food layer of matter making up the upper-base (or coating) of strong density on a lighter recipe, for example, a sugar syrup concentrated on a much more fluid basis, mashed fruits on a whipped yoghurt;
the laying of a semi-solid product extruded through the proportioning tube, for example, gelatin in hardening phase or 25° C. chocolate on a fluid cream.

When the upper-base is a coating, one can also lay on its top, as a decoration, a foam or a whipped cream or particles such as dry or crystallized fruit fragments; nut fragments, hazelnuts, almonds, citrus peels; cereals or confectionery vermicelli.

The process according to the invention allows in particular a laying of the upper-base (or surface) having a determined aspect, following both the shape of the tube openings and the way in which these openings are open.

One can thus carry out the laying of a ventilated layer of a dense product, such as for example gelatin vermicelli, or any other shape depending on the openings of tube (broad or thin flat straps, etc).

Following an advantageous aspect of the invention, the abovementioned process can be used to carry out multi-layer separations aiming at limiting exchanges between two masses.

One can thus separate by a coating a first food mass of component made up, for example, by an acid component such as a fruit purée or a whipped lacteous phase, such as a whipped cream or a sweetened whipped cream, or an acidic or fermented dairy product, from a second mass made up, for example, of another lacteous phase, such as a foam or a cream, the two masses being able to be in the opposite order compared to the coating which separates them.

In this case, one proceeds for example in the following way: one carries out the proportioning of the first mass, then the proportioning of the coating, then the proportioning of the second mass.

The upper-base (or coating) thickness can be adapted depending on the expected result, without technical limitation; it preferably will lie, between 0.3 mm to 6 mm, in particular between 0.5 and 1.5 mm, to preserve a nice breakable layer for the spoon when it is a layer containing fat content such as for example chocolate or a product containing chocolate.

The laying of a thicker upper-base does not bring any problem and can be obtained by proportioning techniques known to specialist professionals.

The invention also involves, according to a later object, a multi-layer foodstuff, notably a multi-layer dessert, likely to be obtained by the above mentioned process, including at least a sub-base and an upper-base (or coating), each layer containing thermally stable food components. Valuably, the aforementioned upper-base (or coating) displays a uniform distribution.

The invention relates to a multi-layer foodstuff in particular, likely to be obtained by the above-mentioned process, including at least a sub-base and an upper-base (or coating) containing thermally stable food components, in which the aforementioned sub-base has a low viscosity.

The preferential aspects of the process, as described above, also apply to multi-layer foodstuffs according to the invention.

In particular, the food matter constituting the aforementioned upper-base can be a fat content or a mixture of fat contents, or can be selected among sugar syrups, products containing fruits, products containing milk, alone or in mixture with one or more food additives, such as abovementioned.

As indicated above, the food matter making up the upper-base includes one or more additional ingredients, in particular particle-shaped additives, those possibly being in between two coatings.

Gainfully, the thickness of the upper-base (or coating) lies between 0.3 and 6 mm, preferably between 0.5 and 1.5 mm.

The invention relates to multi-layer foodstuffs in particular in which at least a sub-base is hydrophilic and at least an upper-base (or coating) is hydrophobic, and in which at least a sub-base has a low viscosity.

Among those, those in which the sub-base consists of an acidic or fermented dairy product, in particular yoghurt or fresh cheese, are particularly preferred.

Other favored multi-layer foodstuffs are those whose sub-base has a Bostwick consistency higher than 8 cm, or those whose sub-base has a viscosity from approximately 3000 to 25000 mPa·s, preferably from approximately 8000 to 20000 mPa·s.

According to another advantageous aspect, the multi-layer foodstuff following the invention includes only one sub-base of food component to cover and only one upper-base with food matter covering the aforementioned sub-base.

Alternatively, the aforementioned multi-layer foodstuff can include an alternation of sub-base and upper-base, the aforementioned upper-base itself being able to consist of several layers

Besides, the invention relates to a device implementing the process according to the invention, including proportioning means of the food matter making up the upper-base (or coating) by the only effect of gravity of the aforesaid food matter, distribution means and positioning means of the container containing the product to be covered.

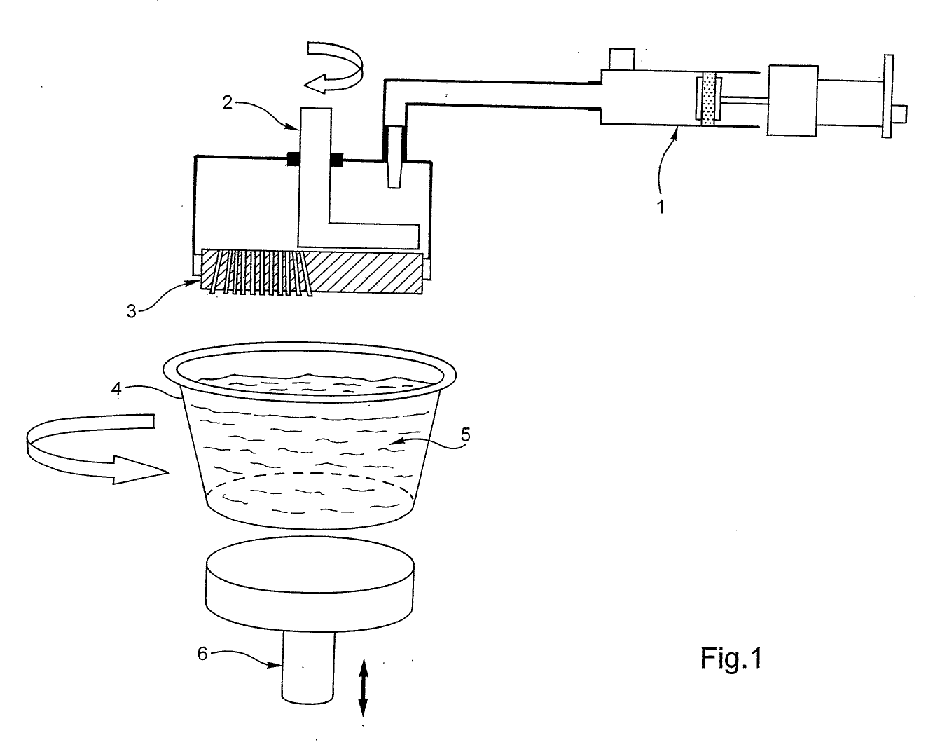

An example of such a device is displayed on FIG. 1, which shows a proportioning piston (1) intended to push the food matter making up the upper-base (or coating) connected to a rotating bushel (2) likely to release the multiple openings of a plate of tube (3), and a container (4) containing the product to be covered (5), the aforementioned container which can be fixed with a rotating rising and falling system (6) allowing its positioning and its movement.

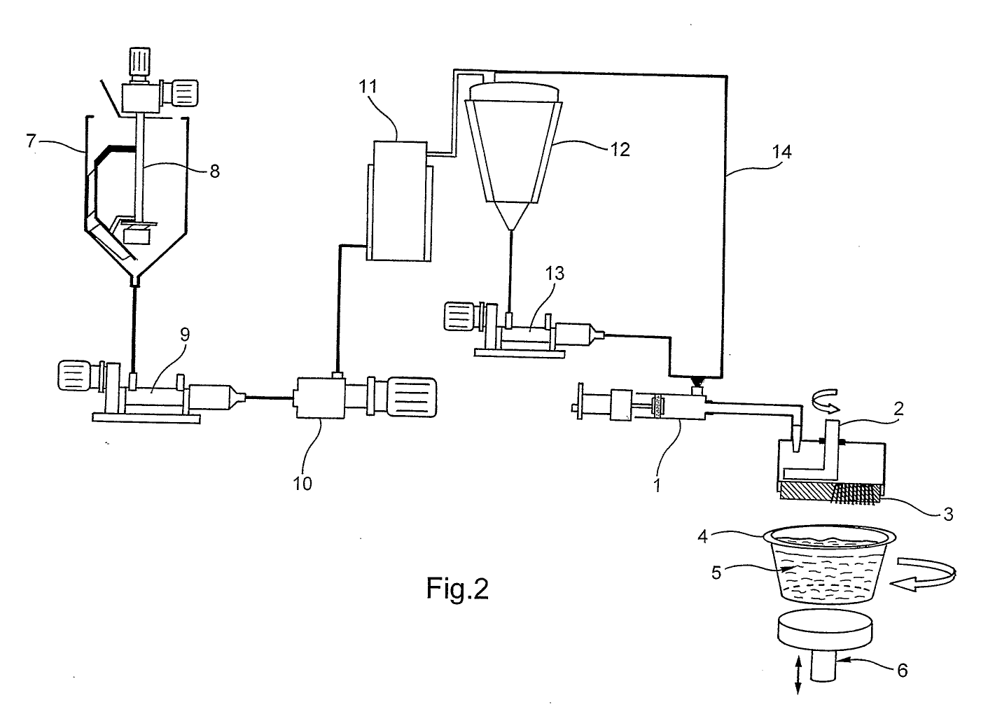

FIG. 2 is a diagrammatic display of an example device for the implementation of the inventive process allowing the production and the proportioning of the upper-base (or coating) and obtaining a multi-layer foodstuff including a sub-base of product to be covered and a coating: in a tank (7), one adds the various components of the food matter making up the coating. The mixer (8) ensures a homogeneous mixture, which is sterilized at high temperature. The pump (9) sends the mass sterilized towards a dynamic system of homogenization (10), and the product is brought back to a temperature lower than the temperature of sterilization by a heat exchanger (11), then stored in a tank (12) which supplies a pump (13) connected to a proportioning piston (1) connected to a rotating bushel (2) likely to release the multiple openings of a plate of tube (3), and a container (4) containing the product to be covered (5), the aforementioned container being fixed with a rotating system of rise and fall (6). The surplus food matter making up the coating is returned by a circuit (14) to the tank (12).

The invention is incomprehensively illustrated in the examples below:

### EXAMPLE 1

### Preparation of a Vanilla Flavor Crème Dessert and of a Chocolate Flavor Crème Dessert, Covered with a Food Layer of Matter Containing a Chocolate Base

The multi-layer foodstuffs were prepared whose composition is indicated in table 1 below:

TABLE 1

| | vanilla flavor | chocolate flavor |
|---|---|---|
| | crème dessert | crème dessert |
| Ingredients | (% of weight) | (% of weight) |
| Skimmed milk | 60 to 70 | 60 to 70 |
| Glucose syrup | 0 to 12 | 0 to 12 |
| Cream 30% fat content | 1 to 20 | 1 to 20 |
| Sugar- saccharine | 4 to 12 | 4 to 12 |
| Milk proteins | 0 to 4 | 0 to 4 |
| Modified starch E1442 | 1 to 3.5 | 1 to 3.5 |
| Carragheenans | 0.05 to 0.5 | 0.05 to 0.5 |
| Flavoring and coloring | 0.1 to 1.2 | 0 to 0.5 |
| Cocoa powder for | — | 1 to 3.5 |
| 10-12 or 20-22% fat content | | |
| Chocolate | — | 1 to 6 |
| TOTAL | 100 | 100 |

One proceeds in the following way:

1—One premixes the pulverulent ingredients, then one humidifies the mixture with hot milk. Cream is added and the chocolate melted at 38° C. and one subjects to a UHT treatment at 130° C. during some s. After cooling at between 10 and 20° C., the crème dessert is stored out of tank while waiting for proportioning. The transfer to a proportioning unit is done by means of a pumping plant.

2—For the upper-base, one proceeds in the following way: one pre mixes the pulverulent ingredients and one adds in cocoa butter and chocolate melted at 38° C. This mixture undergoes a sterilization heat treatment, for example between 110° C. and 120° C. during 8-15 min, the treatment being adapted according to the water activity. Before cooling between 60-70° C., the product undergoes a homogenizing treatment to make the product smooth. Storage is made in tank while waiting for proportioning at a 60-70° C. temperature. The transfer to a proportioning unit is done by means of a pumping plant.

3—For proportioning: one fills the container in first with the crème dessert at a temperature of 10 to 20° C. For example, in a plastic container 110 ml in total volume and diameter 95 mm, one proportions 90 g of crème dessert. Then the container is brought under the proportioning unit of the upper-base, one proceeds then by rising this container by means of a jack to an expected height for the tube's plate, being 20 to 60 mm the proportioning of the upper-base is done at the same time as the rotation of the container in order to spread this layer harmoniously, the force being then 3 to 5 s⁻¹. The proportioning temperature of the upper-base is adjustable between 50 and 60° C. to ease the flow according to the surface of the sub-base. The quantity of upper-base laid is regulated from 6 to 10 g per container for a 100 ml container.

One obtains a uniform coating having a thickness from 0.5 to 3 mm At the end of this proportioning, one keeps rotating the container until its descent and its passage through the opening sealing step and then packaging and grouping if necessary. The product is then put to cool until a heart temperature lower than 6° C. is reached.

### EXAMPLE 2

### Preparation of a Whipped Yoghurt Covered with a Food Layer of Fruit-Base Matter

The multi-layer foodstuff was prepared following the content displayed in table 2 below:

TABLE 2

| Ingredients | % of weight |
|---|---|
| Skimmed milk | 70 to 80 |
| Cream 30% fat content | 1 to 12 |
| Sugar - saccharine | 6 to 10 |
| Milk proteins | 1.5 to 4 |
| Yoghurt stocks/culture | 1 to 3 |
| Flavoring and coloring | qsp |
| Fruit-base preparation | qsp |
| TOTAL | 100 |

One proceeds in the following way:

1—One premixes the pulverulent ingredients, then one humidifies the mixture with milk. One adds cream if necessary, and one subjects to a pasteurization at 90-105° C. during some min. After homogenization at a pressure from 50 to 300 bars, one cools at a fermenting temperature of approximately 40° C. and one sows with the yoghurt ferments (Lactobacillus bulgaricus and Streptococcus thermophilus). One lets ferment in the tank until a pH from 4.1 to 4.7, then one agitates and one cools with 10° C. Storage is made in tank while waiting for proportioning. The transfer to a proportioning unit is done by means of a pumping plant.

2—For the upper-base, one uses a pasteurized preparation containing fruits (50-60%), sugars and glucose syrup (20 to 40%) and, depending on the fruit, with a stabilization containing pectin or gum xanthane. This preparation is stored in a tank or a container, the transfer to a proportioning unit is done by means of a pumping plant.

3—For proportioning: one fills the container in first with yoghurt whipped at a temperature from 10 to 20° C. For example, in a plastic container 110 ml of total volume, one proportions 90 G of whipped yoghurt. Then, the container is brought under the proportioning unit of the upper-base, and one proceeds then by rising this container by means of a jack with an expected height of the for the tube's plate, being 20 to 60 mm the proportioning of the upper-base is done at the same time as the rotation of the container in order to spread this layer harmoniously, the centrifugal force is then 1 to 3 s-1. The temperature of proportioning of the upper-base being between 30 and 40° C. The quantity of upper-base laid is regulated to 8 to 12 g per container for a 100 ml container. One obtains a uniform coating having a thickness from 0.8 to 3 mm. At the end of this proportioning, one keeps rotating the container until its descent and its passage through the opening sealing step and then packaging and grouping if necessary. The product is then put to cool until a heart temperature lower than 6° C. is reached.

### EXAMPLE 3

### Preparation of Vanilla Flavor Egg Pudding and of Chocolate Flavor Egg Pudding, Covered with a Chocolate-Base Food Layer

The multi-layer foodstuff was prepared following the content displayed in table 3 below:

TABLE 3

| | vanilla flavor egg | chocolate flavor egg |
|---|---|---|
| | pudding | pudding |
| Ingredients | % of weight | % in weight |
| Skimmed milk | 35 to 80 | 35 to 80 |
| Glucose syrup | 0 to 12 | 0 to 12 |
| Cream 30% fat content | 1 to 35 | 1 to 35 |
| Sugar - saccharine | 4 to 11 | 4 to 11 |
| Milk proteins | 1 to 2 | 1 to 2 |
| Modified starch E1442 | 0.5 to 2 | 0.5 to 2 |
| Flavoring and coloring | 0.1 to 0.5 | |
| Cocoa powder for 10-12 or | | 1 to 3 |
| 20-22% fat content | | |
| Chocolate | | 1 to 6 |
| Eggs | 10 to 15 | 10 to 15 |
| TOTAL | 100 | 100 |

One proceeds in the following way:
1—One premixes the pulverulent ingredients, then one humidifies the mixture with hot milk. One adds cream and chocolate melted at 38° C. and one subjects to a UHT treatment at 130° C. during some s. After cooling at 50-70° C., one adds liquid eggs, one fills the container and one cooks in an oven during 20-45 min with 85.-95° C. The containers are put to wait on an accumulation carpet before the proportioning of the upper-base. The temperature of the product should not be lower than 70° C.

2—For the upper-base, one proceeds in the following way: the pulverulent ingredients are premixed and one adds cocoa butter and chocolate melted at 38° C. This mixture undergoes a sterilization heat treatment at 110° C. during 10 min. Before cooling between 60-70° C., the product undergoes a homogenization treatment to make the product smooth. Storage is made in tank while waiting for proportioning at a 60-70° C.

The transfer to I unity of proportioning is done by means of a pumping plant.

3—For proportioning: the container outside the oven is brought under the portioning unit of the upper-base and one proceeds then by rising this container by means of a jack to an expected height for the tube's plate, being 20 to 60 mm the proportioning of the upper-base is done at the same time as the rotation of the container in order to spread this layer harmoniously, the force being then 3 to 5 s⁻¹. The temperature of proportioning of the upper-base is regulated between 60 and 75° C. The quantity of upper-base deposited is regulated, for a 100 ml container, to 6 to 10 G per container. One obtains a uniform coating having a thickness from 0.5 to 3 mm One obtains a uniform coating having a thickness from 0.5 to 3 mm At the end of this proportioning, one keeps rotating the container until its descent and its passage through the opening sealing step and then packaging and grouping if necessary. The product is then put to cool until a heart temperature lower than 6° C. is reached.

1.-36. (canceled)

37. A process for preparing a multi-layer foodstuff product that includes at least a sub-base layer and an upper-base layer, with each layer containing thermally stable food components and the sub-base layer has a lower viscosity than the upper-base layer, which comprises proportioning food matter that is to make up the upper-base layer and distributing that food matter onto a sub-base layer provided in a container with the food matter distributed using a rotating mechanical bushel through a plate provided with multiple openings while simultaneously subjecting the container to rotation to apply a centrifugal force to the food matter of the upper-base layer to form the product.

38. The process of claim 37, wherein the upper-base layer has a fat content or is hydrophobic while the sub-base layer is hydrophilic.

39. The process of claim 37, wherein the sub-base layer has a viscosity of from about 3000 to 25000 mPa·s.

40. The process of claim 37, wherein the aforementioned sub-base has a Bostwick consistency higher than 8 and the food matter making up the upper-base layer has a fat content or a mixture of fat content based on chocolate or vegetable fat.

41. The process of claim 40, wherein the fat content is a chocolate that includes a mixture of another vegetable fat, cocoa butter, cocoa powder or liquor or a mixture of cocoa power or liquor with cocoa butter or another vegetable fat in an amount of at least 50% by weight of the mixture.

42. The process of claim 37, wherein the food matter for the upper-base layer comprises sugar syrups, products containing fruits, or products containing milk, and are present alone or in mixture with one or more food additives.

43. The process of claim 37, wherein the upper-base layer has a thickness of between 0.3 mm and 6 mm and the food matter making up the upper-base layer includes one or more ingredients chosen from thickening, gelling, or texturing agents, natural or artificial dyes or natural or artificial flavors.

44. The process of claim 37, wherein the food matter making up the upper-base layer includes particle-shaped additives of dry or crystallized fruit fragments, nut fragments, citrus peels, cereals or confectionery vermicelli.

45. The process of claim 44, wherein the particle-shaped additives are thermically treated in the food matter making up the upper-base layer.

46. The process of claim 44, wherein the upper-base is prepared by first laying a layer of the food matter making up the upper-base layer, applying the particle-shaped additives and then applying a further layer of the food matter.

47. The process of claim 44, wherein the particle-shaped additives are applied onto the food layer of the upper-base layer before cooling of that layer.

48. The process of claim 37, wherein the sub-base layer is an acidic or fermented dairy product, a foam, cream, a product containing fruit, a product containing cereal, a fermented product containing cereal, a product containing egg, or a product containing soya.

49. The process of claim 37, wherein the food matter making up the upper-base layer is proportioned using a proportioning piston.

50. The process of claim 49, wherein the proportioning piston is configured and dimensioned to release the food matter by gravity discharge.

51. The process of claim 37, wherein the force applied to the container is a centrifugal force of about 1 to 5 s-1.

52. The process of claim 44, wherein the temperature during the release of the food matter to prepare the upper-base layer is about 30 to 75° C.

53. A foodstuff multi-layer product prepared by the process of claim 37.

54. A foodstuff multi-layer product including at least a sub-base layer and an upper-base layer, wherein each layer contains thermally stable food components, and in which the sub-base layer has a lower viscosity than the upper-base layer.

55. The product according to claim 54, wherein the upper-base layer exhibits a uniform distribution, and which includes one or more sub-base layers and one or more upper-base layers where the layers alternate when multiple layers are present.

56. A device for the implementation of the process according to claim 37, which comprises proportioning means for the food matter making up the upper-base layer wherein the proportioning means is configured and dimensioned to release the food matter by gravity discharge, a container for preparing and holding the sub-base layer and final product, and means for distributing the food matter onto the sub-base layer while rotating the container to form the product.

57. A device for preparing a multi-layer foodstuff product that includes at least a sub-base layer and an upper-base layer, with each layer containing thermally stable food components and the sub-base layer has a lower viscosity than the upper-base layer, which comprises proportioning means for the food matter making up the upper-base layer wherein the proportioning means is configured and dimensioned to release the food matter by gravity discharge, a container for preparing and holding the sub-base layer and final product, and means for distributing that food matter onto the sub-base layer provided in the container with the food matter distributed using a rotating mechanical bushel through a plate provided with multiple openings while simultaneously subjecting the container to rotation to apply a centrifugal force to the food matter of the upper-base layer to form the product.
